(19) United States
(12) Patent Application Publication
(10) Pub. No.: US 2010/0044093 A1
(43) Pub. Date: Feb. 25, 2010

(54) LAYOUT GEOMETRIES FOR DIFFERENTIAL SIGNALS

(75) Inventors: Kaveh Moazzami, San Diego, CA (US); Mahdi Bagheri, Carlsbad, CA (US); Edris Rostami, San Diego, CA (US); Rahim Bagheri, Carlsbad, CA (US)

Correspondence Address: FOUNTAINHEAD LAW GROUP, PC;Chad R. Walsh, 900 LAFAYETTE STREET, SUITE 200, SANTA CLARA, CA, 95050, US

(73) Assignee: WiLinx Corporation, Carlsbad, CA (US)

(21) Appl. No.: 12/197,866

(22) Filed: Aug. 25, 2008

(51) Int. Cl. H01R 12/04

(52) U.S. Cl. 174/264

(57) ABSTRACT

In one embodiment the present invention includes an electrical arrangement comprising conductive elements such as electrical traces. The conductive elements carry differential signals. The conductive elements extend horizontally and have alternating sections around one or more center lines. Ground lines may be included the further enhance signal integrity. In one embodiment, magnetic field cancellation may be achieved by providing an offset between pairs of alternating differential elements.

### CROSS REFERENCE TO RELATED APPLICATIONS

Not Applicable

### BACKGROUND

The present invention relates to layout, and in particular, to layout geometries for differential electrical signals.

Many electronic applications utilize differential signaling. For example, some applications may use differential signals at low voltage levels to save power while delivering a reliable signal. However, as signal frequencies increase, problems arise in the propagation of differential signals between different circuits of an electrical device. For example, delivering reliable differential signals in communication electronics becomes problematic when employing phase modulation techniques at frequencies of 1 Gighertz or greater. In particular, a system employing quadrature amplitude modulation (QAM) has a an in-phase (I) differential signal and a quadrature phase (Q) differential signal which need to maintain a 90 degree phase difference in order to keep the signals from interfering with each other. The layout of differential signal lines may cause signals to interfere with each other and may cause phase differences in the propagation of the signals. This may cause overall degradation in the signal quality and limit the performance of the application.

Thus, there is a need for improved layout geometries. The present invention solves these and other problems by providing layout geometries for differential signals.

### SUMMARY

Embodiments of the present invention improve layout geometries for differential signals. In one embodiment the present invention includes an electrical arrangement

In one embodiment, the present invention includes an electrical arrangement comprising a first conductive element extended horizontally having alternating sections around a first horizontal center line and a second conductive element extended horizontally having alternating sections around the first horizontal center line, wherein the first conductive element and the second conductive element are symmetrical around the first horizontal center line.

In one embodiment, the alternating sections of the first conductive element and the alternating sections of the second conductive element are equal length.

In one embodiment, the electrical arrangement further comprises a third conductive element extended horizontally with the first and second conductive elements and a fourth conductive element extended horizontally with the first and second conductive elements, wherein the third conductive element and fourth conductive element are symmetrical around the first horizontal center line.

In one embodiment, the first and second conductive elements include a plurality of alternating points, wherein the third and fourth conductive elements include a plurality of alternating points, wherein the alternating points of the first and second conductive elements are arranged at a location that is offset from the alternating points of the third and fourth conductive elements.

In one embodiment, the third and fourth conductive elements are coupled to ground.

In one embodiment, the electrical arrangement further comprises a third conductive element extended horizontally with the first and second conductive elements and having alternating sections around a second horizontal center line and a fourth conductive element extended horizontally with the first and second conductive elements and having alternating sections around the second horizontal center line. The third conductive element and fourth conductive element are symmetrical around the second horizontal center line.

In one embodiment, the first and second conductive elements carry a first differential signal and the third and fourth conductive elements carry a second differential signal.

In one embodiment, the first differential signal is an in-phase signal and the second differential signal is a quadrature signal.

In one embodiment, the alternating sections of the first, second, third, and fourth conductive element are arranged in parallel.

In one embodiment, the alternating sections of the first and second conductive elements are offset from the alternating sections of the third and fourth conductive elements.

In one embodiment, the first and second conductive elements include a plurality of alternating points, wherein the third and fourth conductive elements include a plurality of alternating points, wherein the alternating points of the first and second conductive elements are arranged at a location that is one-half the distance between alternating points of the third and fourth conductive elements, and wherein the alternating points of the third and fourth conductive elements are arranged at a location that is one-half the distance between alternating points of the first and second conductive elements.

In one embodiment, the electrical arrangement further comprises a fifth conductive element extended horizontally in parallel with the first, second, third, and fourth conductive elements, the fifth conductive element arranged a first distance from the first horizontal center line in a first direction from the first horizontal centerline, wherein the first and second conductive elements are alternately between the fifth conductive element and the first horizontal center line. The arrangement may further include a sixth conductive element extended horizontally in parallel with the first, second, third, and fourth conductive elements, the sixth conductive element arranged the first distance from the first horizontal center line in a second direction opposite the first direction from the first horizontal centerline, wherein the first and second conductive elements are alternately between the sixth conductive element and the first horizontal center line, and wherein the sixth conductive element is arranged the first distance from the second horizontal center line in the first direction from the second horizontal centerline, wherein the third and fourth conductive elements are alternately between the sixth conductive element and the second horizontal center line. Additionally, the arrangement may include a seventh conductive element extended horizontally in parallel with the first, second, third, and fourth conductive elements, the seventh conductive element arranged the first distance from the second horizontal center line in the second direction opposite the first direction from the second horizontal centerline, wherein the third and fourth conductive elements are alternately between the seventh conductive element and the second horizontal center line.

In one embodiment, the first and second conductive elements carry differential signals.

In one embodiment, the conductive elements are metal lines on an integrated circuit.

In one embodiment, the conductive elements are metal lines on a printed circuit board.

In one embodiment, the electrical arrangement further comprises the first conductive element comprises a first conductive trace on a first layer, a first via between the first layer and a second layer, a second conductive trace on the second layer, a second via between the second layer and the first layer, and a third conductive trace on the first layer, wherein the second conductive element on the first layer crosses the second conductive trace on the second layer.

In one embodiment, the first, second, third, fourth, fifth, sixth, and seventh comprise regions where the conductive elements are arranged in parallel. The conductive elements are arranged in a plane that runs through each conductive element and through the first and second center lines in said regions.

The following detailed description and accompanying drawings provide a better understanding of the nature and advantages of the present invention.

### BRIEF DESCRIPTION OF THE DRAWINGS

FIG. 1 illustrates a layout of electrical traces according to one embodiment of the present invention.

FIG. 2A illustrates a layout of electrical traces according to one embodiment of the present invention.

FIG. 2B illustrates a cross section of a portion of the layout shown in FIG. 2.

### DETAILED DESCRIPTION

Described herein are techniques for layout geometries for differential signals. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

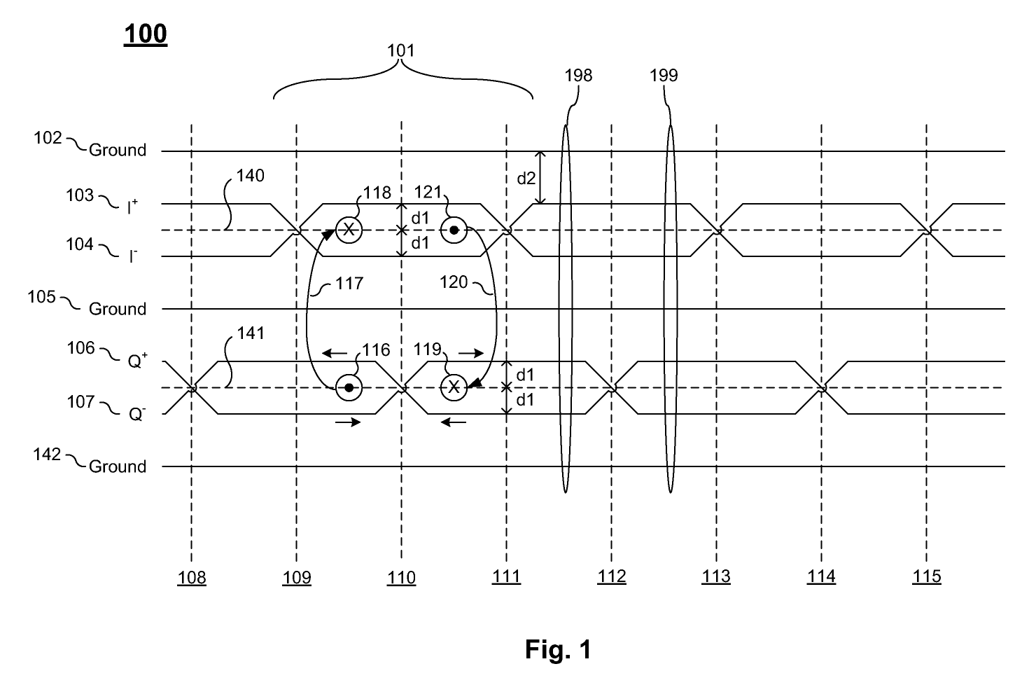

FIG. 1 illustrates an arrangement 100 of electrical traces according to one embodiment of the present invention. Layout 100 includes the following conductive elements: ground 102, I+103, I−104, ground 105, Q+106, Q−107, and ground 142. The conductive elements may be comprised of conductive traces (e.g., metal) and vias on a semiconductor device, printed circuit board, or substrate, for example. The conductive traces of each differential signal are arranged in parallel, and the parallel traces alternate. For instance, conductive element I+103 extends horizontally with alternating sections symmetric around a horizontal center line 140. For example, for conductive trace 103, a section between positions designated by lines 109 and 111 is spaced a distance d1 from the horizontal center line 140 in one direction. Similarly, for conductive trace 104, a section between positions designated by lines 109 and 111 is spaced a distance d1 from the horizontal center line 140 in the other direction. At the position designated by line 111, the traces alternate around the center line. For instance, the layout for traces 103 and 104 each traverse a distance d1 toward each other, cross each other, and traverse a distance d1 away from each other and then continue parallel to each other in a direction of the horizontal center line. Likewise, for the the next section between positions designated by lines 111 and line 113, signal line 103 is a distance d1 from horizontal center line 140 in the opposite direction as the previous section and signal line 104 is a distance d1 from the horizontal center line 140 in the opposite direction as the previous section and a distance d2 from trace 103. Accordingly, conductive elements I+103 and I−104 extend horizontally in the direction of the center line with alternating parallel sections arranged an equal distance from the horizontal center line 140. Conductive elements I+103 and I−104 form parallel sections that are symmetrical around the horizontal center line 140 and alternate (e.g., cross) at intervals. In one embodiment, traces 103 and 104 form a differential pair for an in-phase component of a QAM signal. In one embodiment, the alternating sections of the conductive elements I+103 and I−104 may have equal lengths.

Simlarly, conductive element Q+106 extends horizontally with alternating sections around a horizontal center line 141. For example a section between line 108 and 110 is spaced a distance d1 from horizontal center line 141 in a first direction, the next section between line 110 and line 112 is spaced a distance d1 from horizontal center line 141 in the opposite direction, and the next section between line 112 and line 114 is once again spaced a distance d1 from the horizontal center line 141 in the first direction. Conductive element Q−107 also extends horizontally with alternating sections around the horizontal center line 141. Both conductive elements Q+106 and Q−107 are symmetrical around the horizontal center line 141 and form a differential pair for a quadrature phase component of the QAM signal.

The alternating points of the in-phase conductive elements (I+103 and I−104) are horizontally offset from the alternating points of the quadrature phase conductive elements (Q+106 and Q−107). For instance, in FIG. 1, traces 103 and 104 alternate at a position designated by 109, then continued in parallel between position 109 and 111, and then alternate again at position 111. However, traces 106 and 107 alternate at a position designated by 108, then continued in parallel between position 108 and 110, and then alternate again at position 110. In this example, the offset is half the horizontal length of a parallel section. For example, the quadrature phase conductive elements (Q+106 and Q−107) cross the horizontal center line 141 at line 110 which is the center of a parallel section of the in-phase conductive elements (I+103 and I−104) which begins at line 109 and ends at line 111. Similarly, the in-phase conductive elements (I+103 and I−104) cross the horizontal center line 140 at line 109 which is the center of a parallel section of the quadrature phase conductive elements (Q+106 and Q−107) which begins at line 108 and ends at line 110. This horizontal offset may reduce magnetic coupling between the differential pairs as described in more detail below.

Conductive elements ground 102, ground 105, and ground 142 run horizontally and in parallel with the in-phase and quadrature conductive elements I+103, I−104, Q+106, and Q−107. Conductive element ground 102 runs horizontally in parallel with conductive element I+103 and conductive element I−104. Ground 102 may be spaced a uniform distance from the centerline 140 so that each trace 103 and 104 is alternately the same distance d2 from the ground trace. In particular, trace 103 is a distance d2 from ground 102 between positions 111 and 113. Similarly, trace 104 is a distance d2 from ground 102 between positions 109 and 111. Ground 102 may be positioned in a plane that runs through each trace 104 and 104 and centerline 140. Conductive element ground 105 runs horizontally in parallel with conductive element I+103 and conductive element I−104. Ground 105 may be spaced a uniform distance from the centerline 140 in the opposite direction from ground 102 so that each trace 103 and 104 is alternately the same distance d2 from the ground trace 105. In particular, trace 103 is a distance d2 from ground 105 between positions 109 and 111. Similarly, trace 104 is a distance d2 from ground 105 between positions 111 and 113. Likewise ground 105 may be spaced a uniform distance from the centerline 141 so that each trace 106 and 107 is alternately the same distance d2 from the ground trace 105. In particular, trace 107 is a distance d2 from ground 105 between positions 108 and 110. Similarly, trace 106 is a distance d2 from ground 105 between positions 110 and 112. Conductive element ground 142 runs horizontally in parallel with conductive element Q+106 and conductive element Q−107. Ground 142 may be spaced a uniform distance from the centerline 141 in the opposite direction from ground 105 so that each trace 106 and 107 is alternately the same distance d2 from the ground trace 142. In particular, trace 106 is a distance d2 from ground 142 between positions 108 and 110. Similarly, trace 107 is a distance d2 from ground 142 between positions 110 and 112. Grounds 102, 105, and 142 may be positioned in a plane that runs through each trace 103, 104, 106, and 107 and centerline 140 in regions where the traces are arranged in parallel (e.g., regions 198 and 199).

In one embodiment the ground conductive elements (ground 102, ground 105, and ground 143) may contain vias which couple the conductive elements with a ground plane on another layer of the material (e.g., a substrate or circuit board material). For example, a semiconductor device may have a metal 5 layer and a metal 4 layer including the conductive elements mentioned above, and the ground traces 102, 105, and 142 may have vias which connect the ground lines to a ground plane on a metal 2 layer which may be below several layers of oxide.

Conductive elements I+103 and I−104 have alternating sections which are symmetrical. The symmetry may contribute to providing a matched capacitive coupling between the conductive elements. Conductive elements ground 102 and ground 105 may be symmetrical around horizontal center line 140 and may contribute to providing matching capacitive coupling to ground for the differential pair. Conductive element Q+106 and Q−107 have alternating sections which are symmetrical and may operate similar to the in-phase differential pair of conductive elements. The conductive elements ground 105 and ground 142 may also provide a matching capacitive coupling to Q+106 and Q−107 conductive elements.

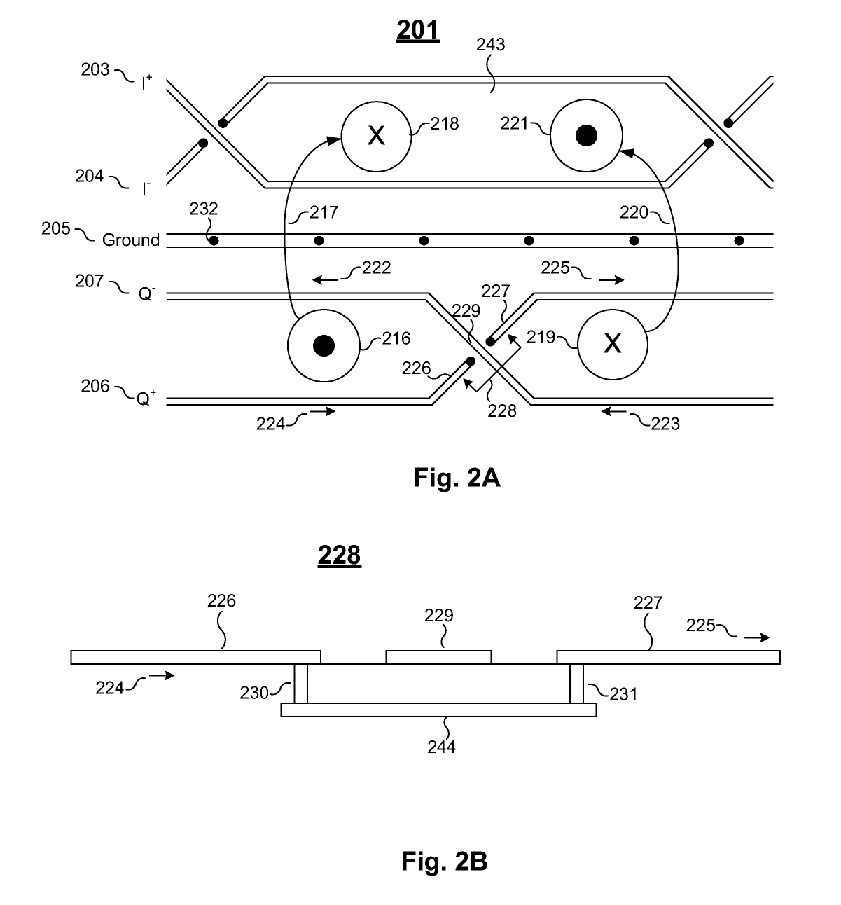

FIG. 2A is a detailed example of an area 201 of a semiconductor device including conductive elements according to an embodiment of the present invention. This figure illustrates how embodiments of the invention may reduce magnetic cross coupling between pairs of differential signals. Detail 201 includes conductive elements I+203, 1−204, ground 205, Q+206, and Q−207. The conductive elements in this embodiment are metal traces which occupy the top two metal layers of a semiconductor device. Conductive element ground 205 includes vias 232 which may couple the conductive element to a ground plane on a another metal layer, for example. Since the signals are differential, each signal pair will genereate opposite currents. For instance, in traces 206 and 207, a current 224 and another current 222 form a loop and generate a magnetic field which points out of the loop (denoted by symbol 216). The field 217 generated out of the page at 216 couples to loop 243 formed by the conductive element I+203 and the conductive element I−204. The field 217 points into the loop 243 (denoted by symbol 218). Current 223 and current 225 in the next segment of traces 206 and 207 (i.e., in the section where the traces run parallel after crossing) form a loop and generate a magnetic field which points into the loop (denoted by symbol 219). The field 220 generated into of the page at 219 couples to loop 243. The field 220 points out the loop 243 (denoted by symbol 221). Field 217 and field 218 may be opposite magnetic fields having approximately the same field strength which may cancel at loop 243. The horizontal offset between the two pairs of differential signals may allow the magnetic coupling between the two pairs of conductive elements to be reduced. This arrangement 201 between conductive elements may reduce the magnetic coupling of other differential pairs being propagated across a distance corresponding to several wavelengths.

FIG. 2B illustrates a cross section 228 of a portion of the layout shown in FIG. 2A. Cross section 228 includes trace 226, via 230, trace 244, via 231, trace 227 and trace 229. This Figure illustrates one technique for alternating the traces. Here a first trace is routed through a via to another layer so that a second trace in the differential signal can cross over the first trace. In this example, trace 226, via 230, trace 244, via 231, and trace 227 show a portion of conductive element Q+206. Trace 229 shows a portion of the conductive element Q−207. It is to be understood that the technique described in this example may be used for the I+ and I− differential conductive elements or for any other routing of differential signals. Trace 244 may be on one metal layer (e.g., metal 4 layer) while the other traces may be on another metal layer (e.g., metal 5 layer). The vias (230 and 231) and the trace 244 may be used to couple sections of the conductive elements 226 and 227 by passing under the portions of the other conductive elements (trace 229 in this case) associated with the other component of the differential pair (Q−207 in this case). The traces can thereby cross each other to implement the alternating symmetry described above.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. It is to be understood that the cross-cancellation techniques describe above can be implemented in different planes and using a variety of different interconnect mechanisms. It is also to be understood that the distances need not be exactly equal and the symmetry need not be perfect symmetry. For instance, if the alternating traces of one pair have different spacing than the alternating traces of the second pair, the benefits of magnetic cancellation will still be obtained. The above embodiments are accordingly examples. Based on the above disclosure and the following claims, other arrangements, embodiments, implementations and equivalents will be evident to those skilled in the art and may be employed without departing from the spirit and scope of the invention as defined by the claims.

What is claimed is:

1. An electrical arrangement comprising:
a first conductive element extended horizontally having alternating sections around a first horizontal center line; and
a second conductive element extended horizontally having alternating sections around the first horizontal center line,
wherein the first conductive element and the second conductive element are symmetrical around the second horizontal center line.

2. The electrical arrangement of claim 1 wherein the alternating sections of the first conductive element and the alternating sections of the second conductive element are equal length.

3. The electrical arrangement of claim 1 further comprising:
a third conductive element extended horizontally with the first and second conductive elements; and
a fourth conductive element extended horizontally with the first and second conductive elements,
wherein the third conductive element and fourth conductive element are symmetrical around the second horizontal center line.

4. The electrical arrangement of claim 3 wherein the first and second conductive elements include a plurality of alternating points, wherein the third and fourth conductive elements include a plurality of alternating points, wherein the alternating points of the first and second conductive elements are arranged at a location that is offset from the alternating points of the third and fourth conductive elements.

5. The electrical arrangement of claim 3 wherein the third and fourth conductive elements are coupled to ground.

6. The electrical arrangement of claim 1 further comprising;
a third conductive element extended horizontally with the first and second conductive elements and having alternating sections around a second horizontal center line; and
a fourth conductive element extended horizontally with the first and second conductive elements and having alternating sections around the second horizontal center line,
wherein the third conductive element and fourth conductive element are symmetrical around the second horizontal center line.

7. The electrical arrangement of claim 6 wherein the first and second conductive elements carry a first differential signal and the third and fourth conductive elements carry a second differential signal.

8. The electrical arrangement of claim 7 wherein the first differential signal is an in-phase signal and the second differential signal is a quadrature signal.

9. The electrical arrangement of claim 6 wherein the alternating sections of the first, second, third, and fourth conductive element are arranged in parallel.

10. The electrical arrangement of claim 7 wherein the alternating sections of the first and second conductive elements are offset from the alternating sections of the third and fourth conductive elements.

11. The electrical arrangement of claim 6 wherein the first and second conductive elements include a plurality of alternating points, wherein the third and fourth conductive elements include a plurality of alternating points, wherein the alternating points of the first and second conductive elements are arranged at a location that is one-half the distance between alternating points of the third and fourth conductive elements, and wherein the alternating points of the third and fourth conductive elements are arranged at a location that is one-half the distance between alternating points of the first and second conductive elements.

12. The electrical arrangement of claim 6 further comprising:
a fifth conductive element extended horizontally in parallel with the first, second, third, and fourth conductive elements, the fifth conductive element arranged a first distance from the first horizontal center line in a first direction from the first horizontal centerline, wherein the first and second conductive elements are alternately between the fifth conductive element and the first horizontal center line;
a sixth conductive element extended horizontally in parallel with the first, second, third, and fourth conductive elements, the sixth conductive element arranged the first distance from the first horizontal center line in a second direction opposite the first direction from the first horizontal centerline, wherein the first and second conductive elements are alternately between the sixth conductive element and the first horizontal center line, and wherein the sixth conductive element is arranged the first distance from the second horizontal center line in the first direction from the second horizontal centerline, wherein the third and fourth conductive elements are alternately between the sixth conductive element and the second horizontal center line; and
a seventh conductive element extended horizontally in parallel with the first, second, third, and fourth conductive elements, the seventh conductive element arranged the first distance from the second horizontal center line in the second direction opposite the first direction from the second horizontal centerline, wherein the third and fourth conductive elements are alternately between the seventh conductive element and the second horizontal center line.

13. The electrical arrangement of claim 12 wherein the first, second, third, fourth, fifth, sixth, and seventh comprise regions where the conductive elements are arranged in parallel and wherein the conductive elements are arranged in a plane that runs through each conductive element and through the first and second center lines in said regions.

14. The electrical arrangement of claim 1 wherein the first and second conductive elements carry differential signals.

15. The electrical arrangement of claim 1 wherein the conductive elements are metal lines on an integrated circuit.

16. The electrical arrangement of claim 1 wherein the conductive elements are metal lines on a printed circuit board.

17. The electrical arrangement of claim 1 wherein the first conductive element comprises a first conductive trace on a first layer, a first via between the first layer and a second layer, a second conductive trace on the second layer, a second via between the second layer and the first layer, and a third conductive trace on the first layer, wherein the second conductive element on the first layer crosses the second conductive trace on the second layer.
